(19) United States
(12) Patent Application Publication
(10) Pub. No.: US 2006/0036430 A1
(43) Pub. Date: Feb. 16, 2006

(54) System and method for domain-based natural language consultation

(76) Inventor: Junling Hu, Menlo Park, CA (US)

Correspondence Address: PERKINS COIE LLP, P.O. BOX 2168, MENLO PARK, CA, 94026, US

(21) Appl. No.: 11/194,008

(22) Filed: Jul. 29, 2005

Related U.S. Application Data
(60) Provisional application No. 60/601,580, filed on Aug. 12, 2004.

(51) Int. Cl. G06F 17/21

(52) U.S. Cl. 704/10

(57) ABSTRACT

A technique for domain-based natural language dialogue includes a program that combines a broad-coverage parser with a general-purpose interpreter and a knowledge base to handle unrestricted sentences in a domain, such as the medical self-help domain. The broad-coverage parser may have more than 40,000 words in its dictionary. The general-purpose interpreter may use logical forms to represent the semantic meaning of a sentence. The knowledge base may include a domain of modest size, but the interpretive and inference techniques may be domain independent and scalable.

### BACKGROUND

More than three million medical self-care books are sold each year. Health websites such WebMD attract more than 10 millions visitors each month. However, the information in books or on the Internet is not easily accessible to people. To search for a specific symptom in a book, a reader has to match that to an index, which sometimes is not organized in a way that the reader can use effectively. To search for information on a health website, a user has to type in keywords. Keyword searching normally generates many irrelevant links, not directly related to the user's symptoms. On WebMD, symptoms are organized by body parts. After a user chooses “knee”, there is a long list of items such as “leg injuries”, “leg problems”, “knee problems and injuries”, “toe, foot and ankle injuries” and so on to choose from. Users have to navigate for a long time to find a specific item related to their problems. Many people give up. Frequently, users cannot find the information they seek.

Some attempts have been made to understand text input from users to make the searching feel more natural in various domains. While these attempts have had some interesting results, natural language understanding is still imperfect. The following references, each of which is incorporated herein by reference, describe various historical and technical aspects related to natural language, dialogue, and knowledge representation for a perspective on the state of the art:

Allen, James F., 1995. Natural Language Understanding, Benjamin Cummings Publishing.

Baader, F. and Bernhard H., 1991. “KRIS: Knowledge Representation and Inference System,” SIGART Bulletin 2,8-14.

Blaylock, N., James Allen, and George Ferguson, 2002. Synchronization in an asynchronous agent-based architecture for dialogue systems. In Proceedings of the 3rd SIGdial Workshop on Discourse and Dialog, Philadelphia.

Borgida, A., Ron Brachman, Deborah McGuinness, and Lori Halpern-Resnick, 1989. “CLASSIC: A Structural Data Model for Objects”, Proc. of the 1989 ACM SIGMOD Int'l Conf. on Data, pp. 59-67.

Colby, K. M., 1999. “Human-Computer Conversation in a Cognitive Therapy Program”, in Yorick Wilks (Editor), Machine Conversations, Kluwer Academic Publishers.

Doyle, Jon and Ramesh Patil, 1991, “Two Theses of Knowledge Representation: Language Restrictions, Taxonomic Classification, and the Utility of Representation Services”, Artificial Intelligence, 48, pp. 261-297.

George Ferguson and James F. Allen, 1998, “TRIPS: An Integrated Intelligent Problem-Solving Assistant,” Proceedings of the Fifteenth National Conference on AI (AAAI-98), Madison, Wis., 26-30.

Goldmann, David R., and Horowitz, David A, 2002, Home Medical Adviser, DK Publishing, New York.

Junling Hu and Michael P. Wellman, 1998. “Online learning about other agents in dynamic multiagent systems”, Proceedings of the Second International Conference on Autonomous Agents.

Junling Hu, Daniel Reeves and Hock-Shan Wong, 2000.“Personalized Bidding agents for Online Auctions”, Proceedings of The Fifth International Conference on The Practical Application of Intelligent Agents and Multi-Agents.

Hwang, C. H. and Schubert, L. K., 1993. “Episodic Logic: A comprehensive, natural representation for language understanding.” Minds & Machines, v. 3 (1993): 381-419.

Karp, Peter D., Suzanne M. Paley, and Ira Greenberg, 1994, “A Storage System for Scalable Knowledge Representation”, in Proceedings of the Third International Conference on Information and Knowledge Management (CIKM'94), Gaithersburg, Md., ACM Press: 97-104.

Krohn, Jacqueline and Taylor, Frances A., 1999, Finding the Right Treatment, Harley and Marks Publishers

Lin, Dekang, 1995, A Dependency-based Method for Evaluating Broad-Coverage Parsers, Proceedings of IJCAI-95.

Lin, Dekang, 1994, PRINCIPAR—An Efficient, broad-coverage, principle-based parser, In Proceedings of COLING-94. pp. 42-488, Kyoto, Japan.

Lin, Dekang, 1993, Principle-based Parsing without Overgeneration, In Proceedings of ACL-93, pp. 112-120, Columbus, Ohio.

Lin, Dekang, and Shaojun Zhao, Lijuan Qin, Ming Zhou. 2003. Identifying Synonyms among Distributionally Similar Words. In Proceedings of IJCAI-03, pp. 1492-1493.

Montague, Richard, 1974. The proper treatment of quantification in ordinary English. In R. Thomason, editor, Formal Philosophy. Selected Papers of Richard Montague. Yale University Press, New Haven.

Schubert, L. K. and Hwang, C. H. (2000), “Episodic Logic meets Little Red Riding Hood: A comprehensive, natural representation for language understanding”, in L. Iwanska and S. C. Shapiro (eds.), Natural Language Processing and Knowledge Representation: Language for Knowledge and Knowledge for Language, MIT/AAAI Press, Menlo Park, Calif., and Cambridge, Mass., 111-174.

L. K. Schubert, “The situations we talk about”, in J. Minker (ed.), Logic-Based Artificial Intelligence, Kluwer, Dortrecht, 2000, 407-439.

C. H. Hwang and L. K. Schubert. “Interpreting tense, aspect, and time adverbials: a compositional, unified approach”, in D. M. Gabbay and H. J. Ohlbach (eds.), Proc. of the 1st Int. Conf. on Temporal Logic, July 11-14, Bonn, Germany, Springer-Verlag, pp. 238-264, 1994.

C. H. Hwang and L. K. Schubert, 1993. “Episodic Logic: A situational logic for natural language processing,” In P. Aczel, D. Israel, Y. Katagiri, and S. Peters (eds.), Situation Theory and its Applications 3 (STA-3), CSLI, 307-452.

Traum, David and Lenhart K. Schubert, Massimo Poesio, Nat Martin, Marc Light, Chung Hee Hwang, Peter Heeman, George Ferguson, and James F. Allen, “Knowledge representation in the TRAINS-93 conversation system,” Intl. Journal of Expert Systems, 9(1), Special Issue on Knowledge Representation and Inference for Natural Language Processing, 1996, pp. 173-223.

Vickery, Donald M., Fries, James F. (2000) Take Care of Yourself, Perseus Publishing.

A computer program capable of conducting natural language dialogue seems fairly reachable at the first glance. After all, sentences are just text strings (for text-based conversation). With today's computers' large memory, it is fairly easy to store large number of sentence patterns, and quickly retrieve them. That is why the first conversational program ELIZA that appeared in the mid-1960's was an attempt to store all possible ways that people can speak. This is also the approach of contemporary chatterbots, including ALICE, Ultra Hal Assistant, Ella, and by commercial talking programs that act as customer service agents All of these programs adopt the ELIZA approach with simply more patterns in their programs. However, this ad hoc approach has problems. The complexity of human language, with its huge number of ways to say similar things, is a technological barrier. This barrier is unlikely to be overcome by simply adding more phrase patterns or sentence templates.

It would be advantageous to develop a conversation program that is based on real language understanding. Real understanding means understanding basic grammar to parse sentence structure, understanding the meaning of words and phrases, and having an internal representation to reason about the meanings. It would further be advantageous to apply the program to a domain, such as the self-help medical domain.

### DESCRIPTION OF THE DRAWINGS

The present invention is illustrated by way of example, and not by way of limitation.

FIG. 1 depicts a system for providing a natural interface for domain-based consultation.

FIG. 2 depicts a domain-based dialogue server for use with the system of FIG. 1.

FIG. 3 depicts a flowchart of an exemplary method for conducting a natural language dialogue with a user.

FIG. 4 depicts a representation of components of an exemplary system for providing a natural language interface for domain-based consultation.

FIGS. 5A to 5D depict screenshots intended to illustrate an exemplary interaction between a user and a domain-based consultation system.

FIGS. 6A to 6D depict screenshots intended to illustrate an exemplary interaction between a user and a domain-based consultation system.

FIGS. 7A to 7H depict screenshots intended to illustrate an exemplary interaction between a user and a domain-based consultation system.

FIGS. 8A to 8F depict screenshots intended to illustrate an exemplary interaction between a user and a domain-based consultation system.

FIG. 9 depicts an exemplary parse tree.

FIG. 10 depicts a flowchart of a method for interpreting a parse tree and mapping to a knowledge base.

FIG. 11 depicts a screenshot of a section of an exemplary knowledge base in database format.

### DETAILED DESCRIPTION OF THE PREFERRED EMBODIMENT

A technique for domain-based natural language dialogue includes a program that combines a broad-coverage parser with a general-purpose interpreter and a knowledge base to handle unrestricted English sentences in a domain, such as the medical self-help domain. The broad-coverage parser may have more than 40,000 words in its dictionary. The general-purpose interpreter may use logical forms to represent the semantic meaning of a sentence. The knowledge base may include a domain of modest size, but the interpretive and inference techniques may be domain independent and scalable.

The technique may be used to build a large-scale dialogue system that is capable of natural language understanding. The system may pave the way for introducing natural language understanding into commercial systems. This may significantly improve the conversational quality of dialogue systems, and therefore make many systems more widely accepted by customers. For example, the improvements over the current customer service agents may put these agents into a prominent role instead of the side role they play now. This may lead to true cost saving for companies that deploy these agents. The improvement for the current training agents may make these agents play a larger role in employee training, or course instruction. All of this may streamline the training process, improve productivity, and reduce human training cost.

The technique may also have deep impact on research in natural language processing, causing future researchers to move away from toy domains with small-scale parsers or special-purpose interpreters. Instead, they may adopt a large-scale parser and general-purpose interpreter, according to embodiments described herein.

The technique should also advance Al in general. A fully functional dialogue agent is one of the ultimate goals of artificial intelligence. The technique may provide the appropriate platform to implement all Al technologies such as learning, reasoning, planning and multiagent interaction (the interaction between the agent and the user).

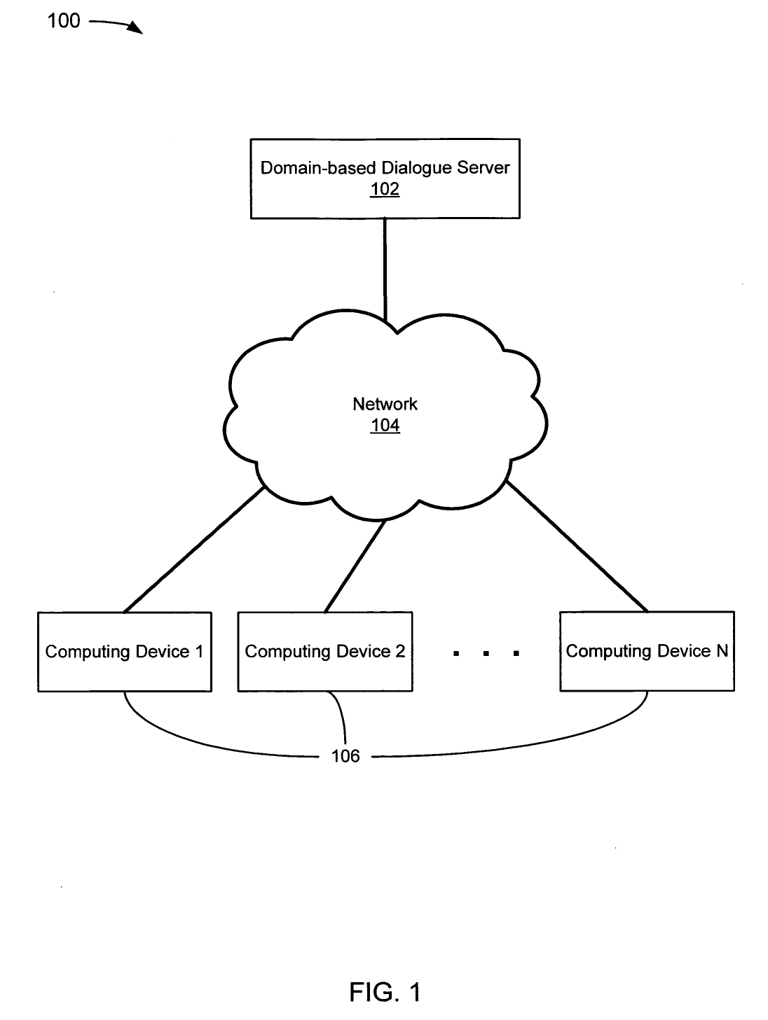

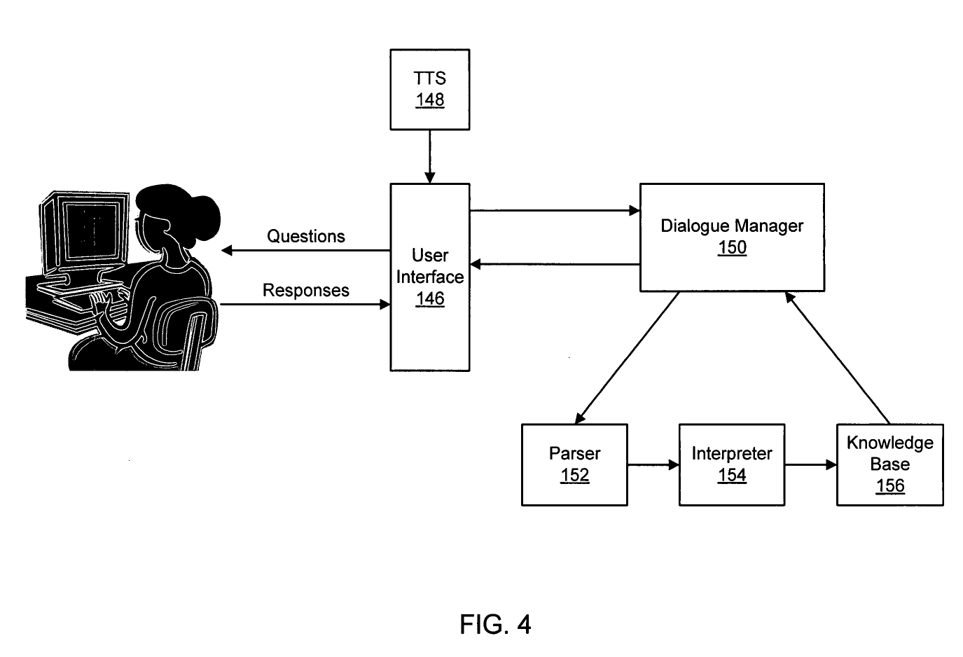

FIG. 1 depicts a system 100 for providing a natural interface for domain-based consultation. The system 100 includes a domain-based dialogue server 102, a network 104, and one or more computing devices 106. The domain-based dialogue server 102 may be any type of computing device or combination of computing devices capable of serving a natural language interface in one or more domains. The domains may be in, for example, the general, medical, psychology, coaching, or some other domain. The domain-based dialogue server may include one or more domains. Alternatively, the domain-based dialogue server 102 could be domain-neutral and access remotely located domains (not shown). In yet another alternative, domains may be stored locally and remotely. Nevertheless, for illustrative purposes, the domain-based dialogue server 102 is treated as having all of the domains stored locally. Domains are discussed in more detail later with reference to FIGS. 4-11.

The network may be any internal network, such as a LAN, WAN, or intranet, or a global information network, such as the Internet. The computing devices 106 communicate with the domain-based dialogue server 102 over the network 104. The computing devices 106 may be any type of computing device including, but not limited to, general purpose computers, workstations, docking stations, mainframe computers, wireless devices, personal data assistants (PDAs), smartphones, or any other computing device that is adaptable to communicate with the domain-based dialogue server 102.

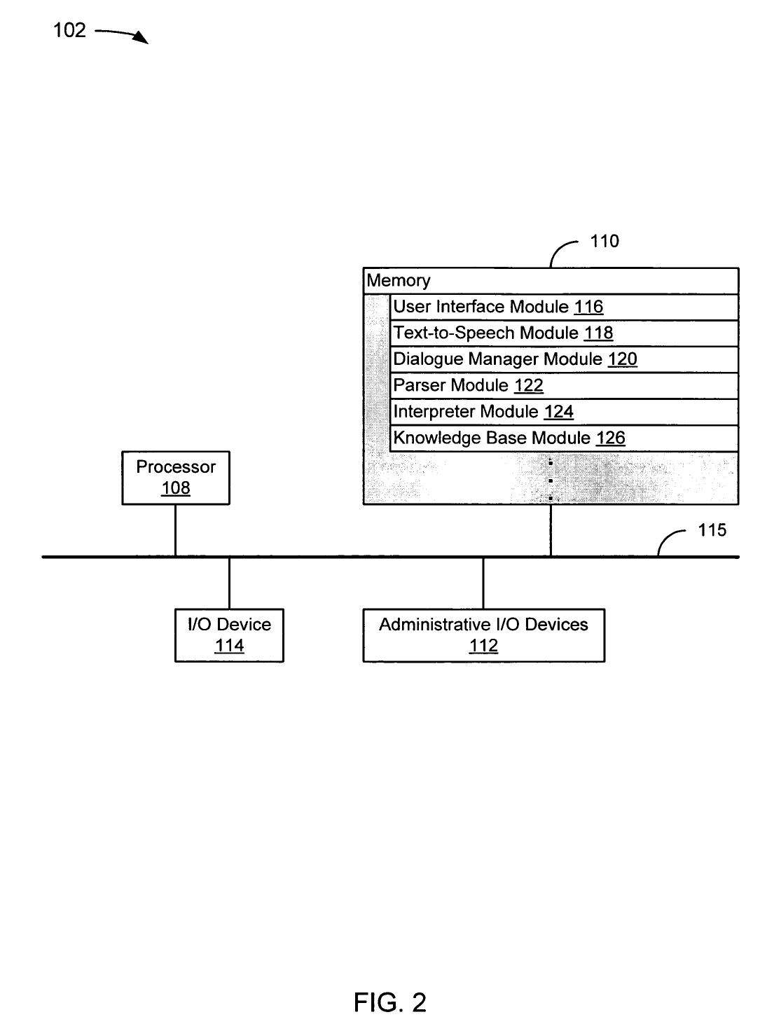

FIG. 2 depicts a domain-based dialogue server 102 for use with the system of FIG. 1. In the example of FIG. 2, the domain-based dialogue server 102 includes a processor 108, memory 110, administrative I/O devices 112, and an I/O device 114. The components are coupled together via a bus 115. The processor 108 may be any device capable of executing code in the memory 110. The memory may include RAM, ROM, magnetic storage, optical storage, DRAM, SRAM, or any other device or component, whether internal or external, that facilitates the storage of information. The administrative devices 112 include any device that facilitates providing input to or output from the domain-based dialogue server 102, including, but not limited to, a keyboard, a mouse, a joystick, a monitor, a modem, or some other device. The I/O device 114 includes any device capable of facilitating communication with a remote device. The I/O device may be an I/O port, channel, modem, or other means.

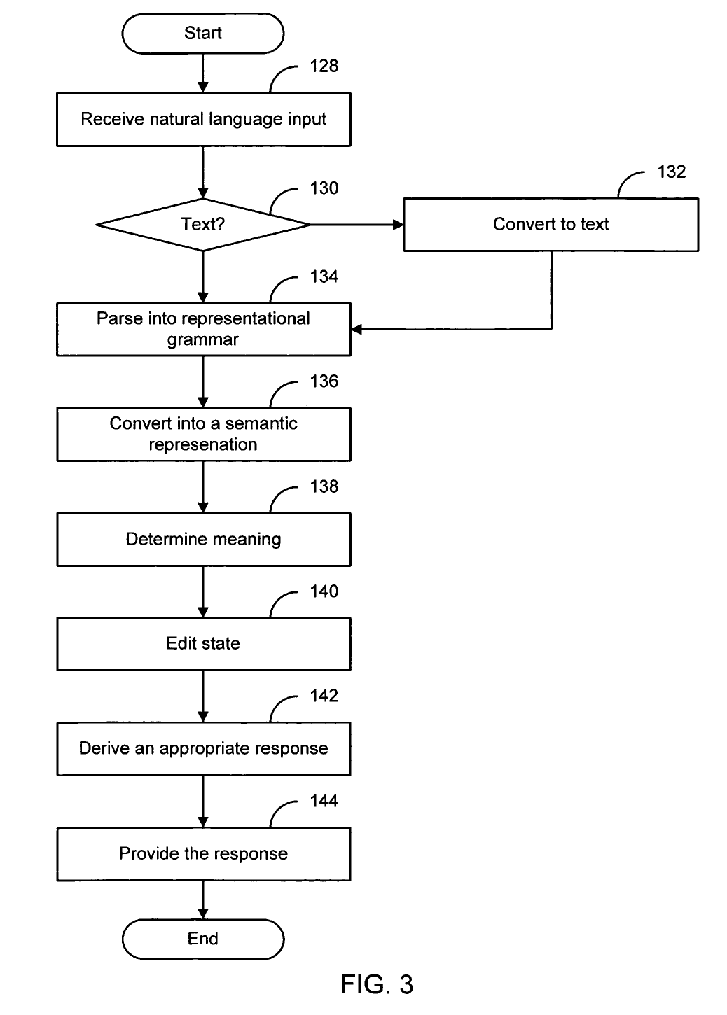

The memory 110 includes one or more executable modules, including a user interface (UI) module 116, a text-to-speech (TTS) module 118, a dialogue manager module 120, a parser module 122, an interpreter module 124, and a knowledge base module 126. These modules may include procedures, programs, functions, interpreted code, compiled code, computer language, databases, or any other type of executable code or stored data. An example of how the modules may be used together to carry out a dialogue with a user is described with reference to FIG. 3.

FIG. 3 depicts a flowchart of an exemplary method for conducting a natural language dialogue with a user. The flowchart represents a single iteration of a dialogue. If the dialogue were to continue, the flowchart would repeat over and over. For illustrative purposes only, it is assumed that the language is English. Of course, any language could be used instead. The flowchart starts at block 128 with receiving natural language from a user. The natural language may be received through an interface, such as an interface provided by a UI module 116 (FIG. 2). The user may enter the natural language through either a local or remote computing device. In an embodiment, the user accesses the interface through the Internet. Natural language may be in a number of formats. For the purposes of illustration, it is assumed that the natural language is either in an understandable text format or an understandable voice format. The text format may be a flat file, though any text format could be implemented. The voice format may be digitized voice, though any voice format could be implemented.

The flowchart continues at decision point 130 with determining whether the natural language input is text or voice. If the natural language input is not text, then at block 132 the natural language input is converted to text using, for example, a TTS module 118 (FIG. 2). In an alternative, the natural language input is always in a text format and the decision point 130 and block 132 are optional. In another alternative, there are multiple different natural language input formats, including analog voice formats.

The flowchart continues at block 134 with parsing text into a representational grammar. In order for a computer to understand a human language such as English, one essential step is parsing. A parser takes an English sentence, analyzes the sentence's structure and decomposes it into a parse tree that includes segments such as noun phrases or verb phrases.

The flowchart continues at block 136 with converting the parse tree into a semantic representation.

The flowchart continues at block 138 with determining meaning from the semantic representation. Determining meaning may require the use of a knowledge base that includes information about entailments of predicates (e.g., that “have a cut” entails “injured”) and about the world (e.g., that injuries generally involve bleeding), and general world knowledge. Moreover, the knowledge base should enable reasoning based on that information. These two types knowledge may be referred to as declarative knowledge and procedural knowledge respectively. The knowledge base may also include decision rules, such as IF-THEN logic.

In a medical domain, the knowledge base may include knowledge (particularly ontology) and structure of the human body and medical symptoms. This knowledge may be from medical ontologies created in the medical community. In addition, if the domain is particularly directed to a medical subcategory, such as self-help, the knowledge base may include another ontology related to, for example, self-care. Such ontology is based on usage by ordinary people, and is a little different from formal medical ontology. A self-help ontology may provide a basic level of understanding of a potential illness based on symptoms people observe at home. Typical medical diagnostic systems may rely on collected data, such as blood samples, that would not be commonly used for self-help diagnosis. Eventually, the self-help ontology may be mapped to formal medical ontology.

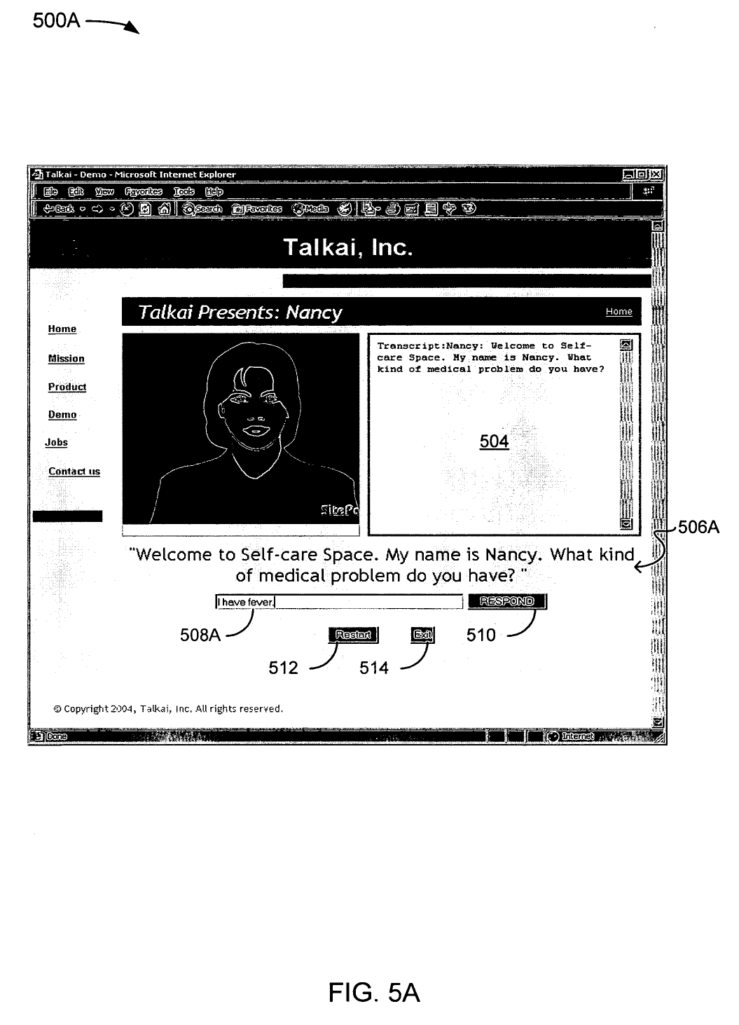

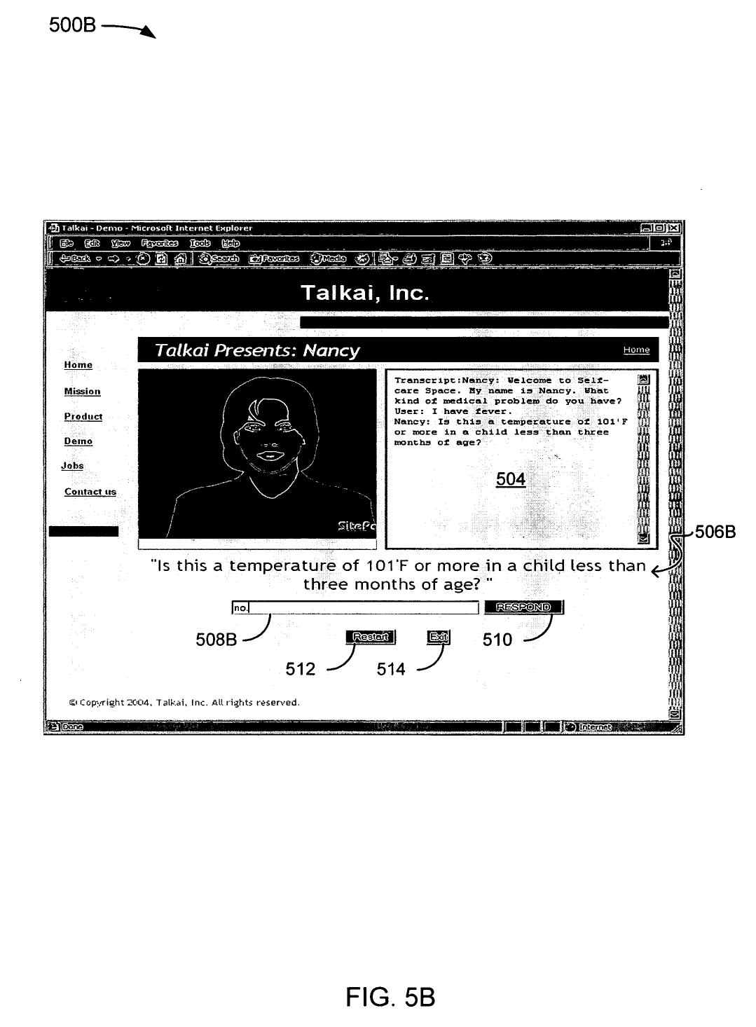

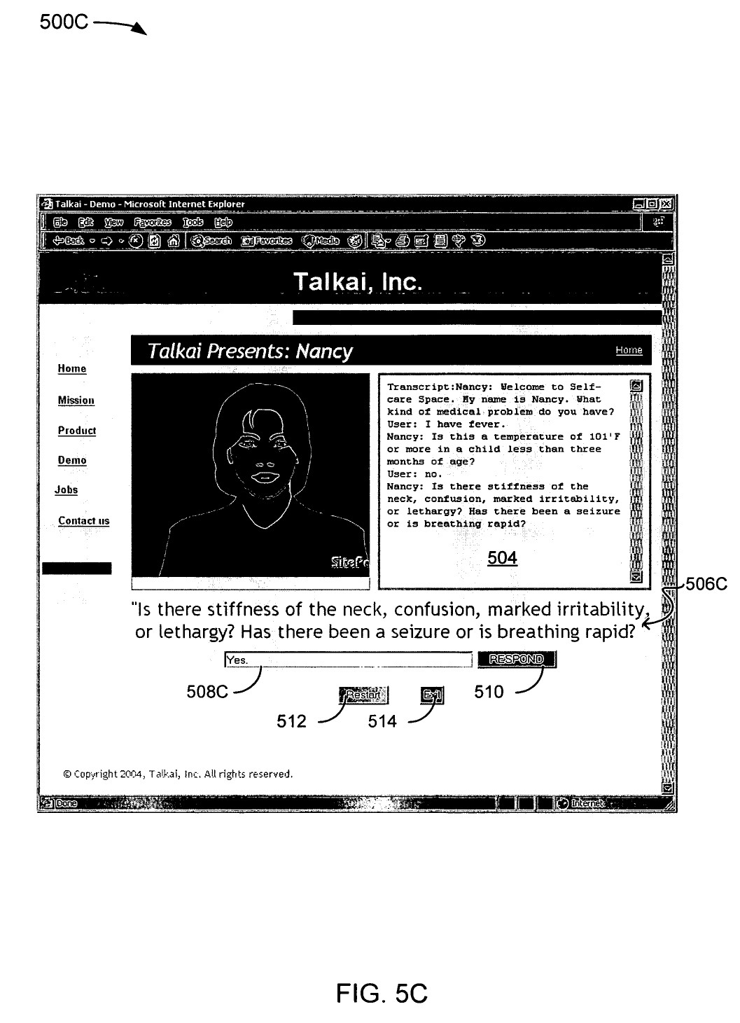

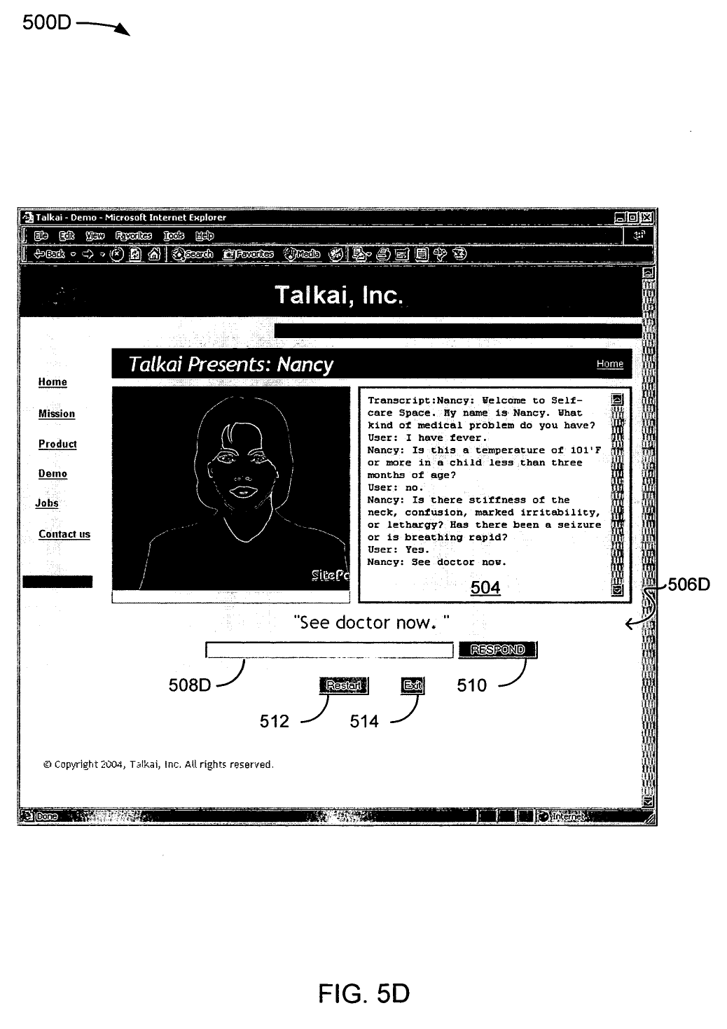

If the system understands received data, then the system can update state to incorporate the new data. Accordingly, the flowchart continues at block 140 with editing state. State represents possibly relevant information that can be drawn upon by the system to respond effectively to natural language input from the user. The system may include a user profile with previously entered data in addition to drawing upon new information from a user over the course of a conversation. An example of dialogue that makes use of state is described later with reference to FIGS. 5-8.

The flowchart continues at block 142 with deriving an appropriate response based on state. An appropriate response may depend upon the natural language input received last. For example, if the natural language input is “Did I mention that my eye hurts, too?” then the appropriate response may begin with a “Yes” or a “No”.

The flowchart ends at block 144 with providing the appropriate response. This may entail displaying the response by way of a UI, using text, voice, or both.

A dialogue manager, such as the dialogue manager provided by the dialogue manager module 120 (FIG. 2), monitors dialogue with a user. Initially, the dialogue manager has a plan, such as opening a conversation with a user. As a dialogue progresses, the dialogue manager may update the plan or spawn sub-plans, which may be question-asking tasks to gather additional information from the user. The dialogue manager also controls interaction with other components, such as a parser, interpreter, knowledge base, or UI. This interaction is illustrated with reference to FIG. 4.

FIG. 4 depicts a representation of the components of an exemplary system for providing a natural language interface for domain-based consultation. The system includes a user interface 146, a TTS 148, a dialogue manager 150, a parser 152, an interpreter 154, and a knowledge base 156. The user interface 146 facilitates a dialogue between a user and the system. The TTS 148 is an optional component for converting voice input from the user into text input. The TTS 148 may also be capable of converting text to voice. The dialogue manager 150 manages the dialogue, starting with a plan to initiate dialogue with a user, adjusting the plan in accordance with the dialogue, and maintaining state. The parser 152, which may be a broad-coverage parser, breaks the natural language input of the user into grammatical units. The interpreter 154, which may be a general-purpose interpreter, puts the grammatical units into a semantic representation, and the knowledge base 156, which may be a domain-based knowledge base, determines the meaning of the input in the context of a domain, such as the medical self-help domain, and determines an appropriate response, which may depend upon state. The plan of the dialogue manager 150 may rely upon decision rules (e.g., IF-THEN rules) in the knowledge base. The decision rules may be referred to as a question-answer flowchart because it may be possible to represent the decision rules as a flowchart.

FIGS. 5A to 5D depict screenshots intended to illustrate an exemplary interaction between a user and a domain-based consultation system. In the example of FIGS. 5A to 5D, the system uses a medical self-help domain. FIG. 5A includes a screenshot 500A of an animated image 502, a transcript 504, a display area 506A, a text box 508A, a respond button 510, a restart button 512, and an exit button 514. For the purposes of illustration only, the interface is within an Internet Explorer™ frame, which includes various menu items and controls that are so well-known that a detailed description is deemed unnecessary.

The animated image 502 may move its lips, have a facial expression, or follow a pointer with its eyes. In certain domains, in particular the self-help domain, it may be desirable to have a realistic animated image. However, the animated image 502 is optional. The transcript 504 is a running display of prompts or responses from the system and inputs from the user. The transcript 504 facilitates checking previous answers, printing the dialogue between the user and the system, or providing the dialogue to a third party, such as a physician or medical diagnostic system. The display area 506A displays the prompt or response from the system. Typically, the display area 506A may include a prompt for information from a user (e.g., a question), a summary or response (e.g., a statement or exclamation), or advice for the user (e.g., a statement or command). The text box 508A includes text input from the user. If the system includes speech-to-text capability, speech may be translated into text and written into the text box 508A. Otherwise, the user may input the text directly. In any case, if the user clicks the Respond button 510, the system receives the input. Alternatively, the user may press the enter key on a keyboard to send the text to the system. If the user clicks the Restart button 512, the transcript 504 is deleted and the system restarts with an initial prompt, such as the one illustrated in the display area 506A. If the user clicks the Exit button 514, then the dialogue ends. The system may or may not update in accordance with the dialogue. A message may or may not be sent to the user or some third party following the end of the dialogue. A detailed description of the display following the end of dialogue is deemed unnecessary, but could be a home page of the company that is presenting the interface to the user.

In the example of FIG. 5A, the system prompts the user with “Welcome to Self-care Space. My name is Nancy. What kind of medical problem do you have?” (display area 506A). The user has responded with “I have fever” (text box 508A).

In FIG. 5B, the system has processed the user's input and has a response, as displayed in the display area 506B, of “Is this a temperature of 101° F. or more in a child less than three months of age?” to which the user has responded, as shown in the text box 508B, with “no”.

In FIG. 5C, the system has processed the user's input and has a response, as displayed in the display area 506C, of “Is there stiffness of the neck, confusion, marked irritability, or lethargy? Has there been a seizure or is breathing rapid?” to which the user has responded, as shown in the text box 508C, with “Yes.”

In FIG. 5D, the system has processed the user's input and has a response, as displayed in the display area 506D of “See doctor now.” The system assumes the dialogue has ended at this point. The user may restart a dialogue, but, for the purposes of example, the text box 508D is left blank.

The dialogue illustrated with reference to FIGS. 5A to 5D could have been accomplished with a keyword-type system instead of a natural language system. For example, a user could type “I have fever” and the system would look up fever and come back with the same response as illustrated in FIG. 5B. However, if the user entered “My child has a fever” then a response of “Is this a temperature of 101° F. or more in a child less than three months of age?” might seem redundant. Moreover, if the user had entered “I have a fever of 103 degrees” a response of “Is this a temperature of 101° F. or more in a child less than three months of age?” would seem illogical.

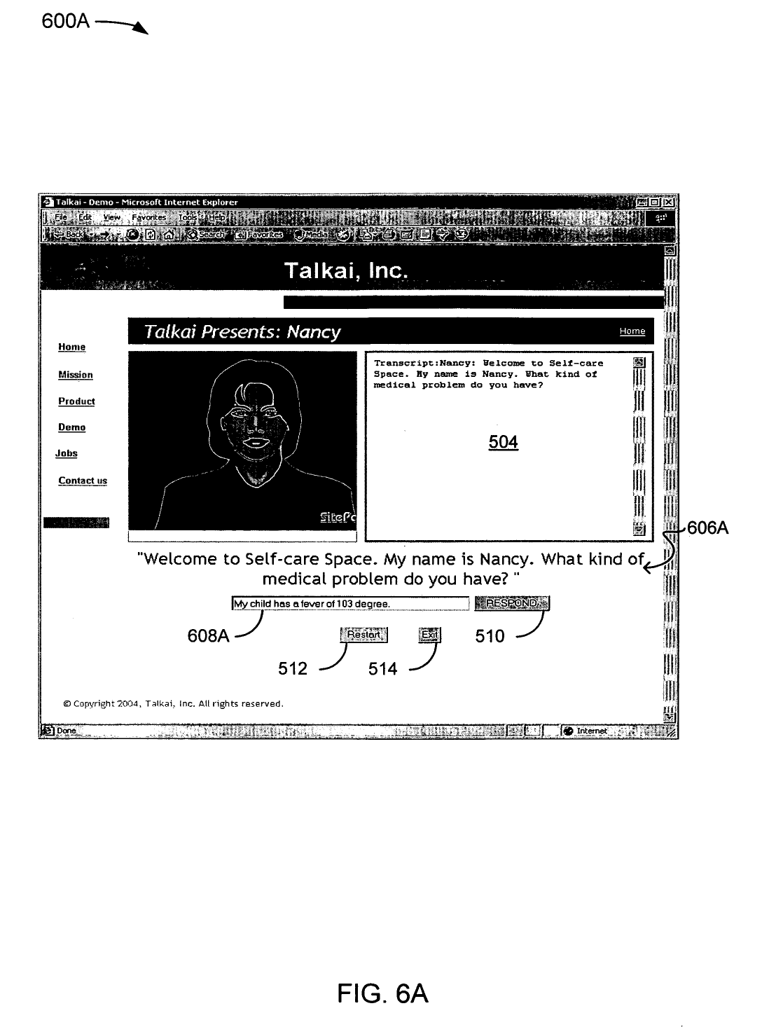

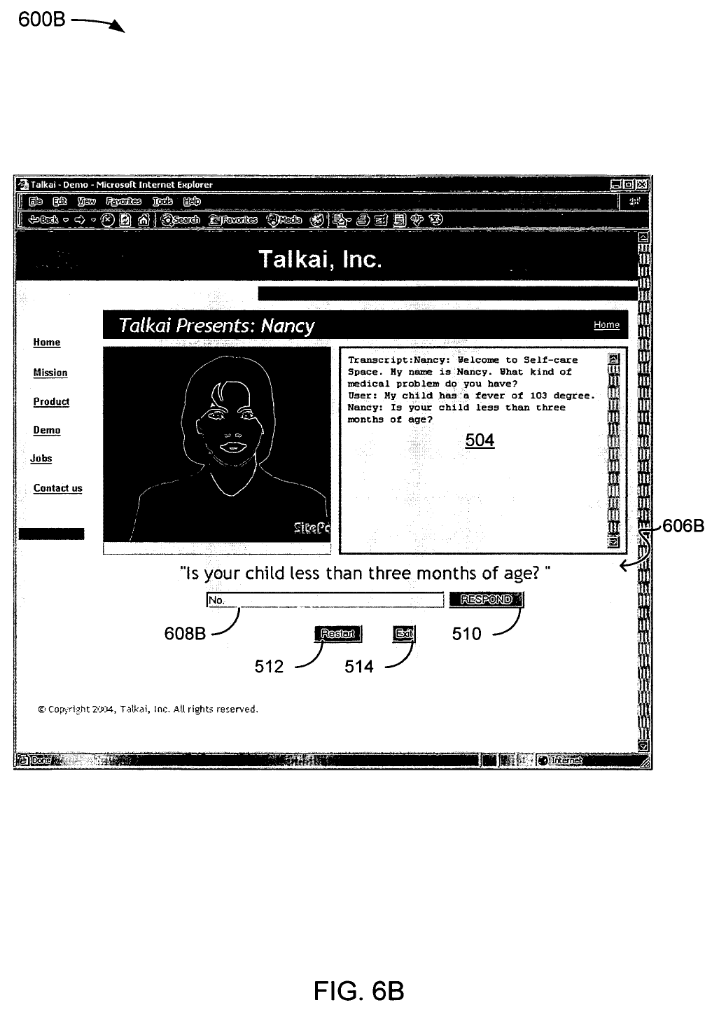

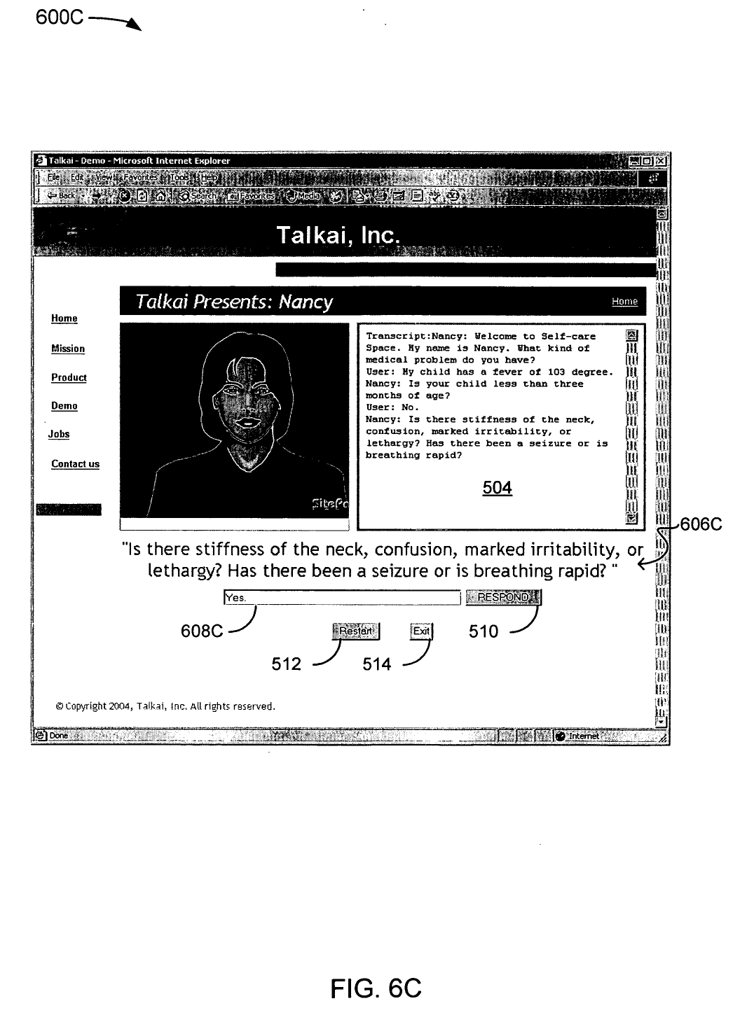

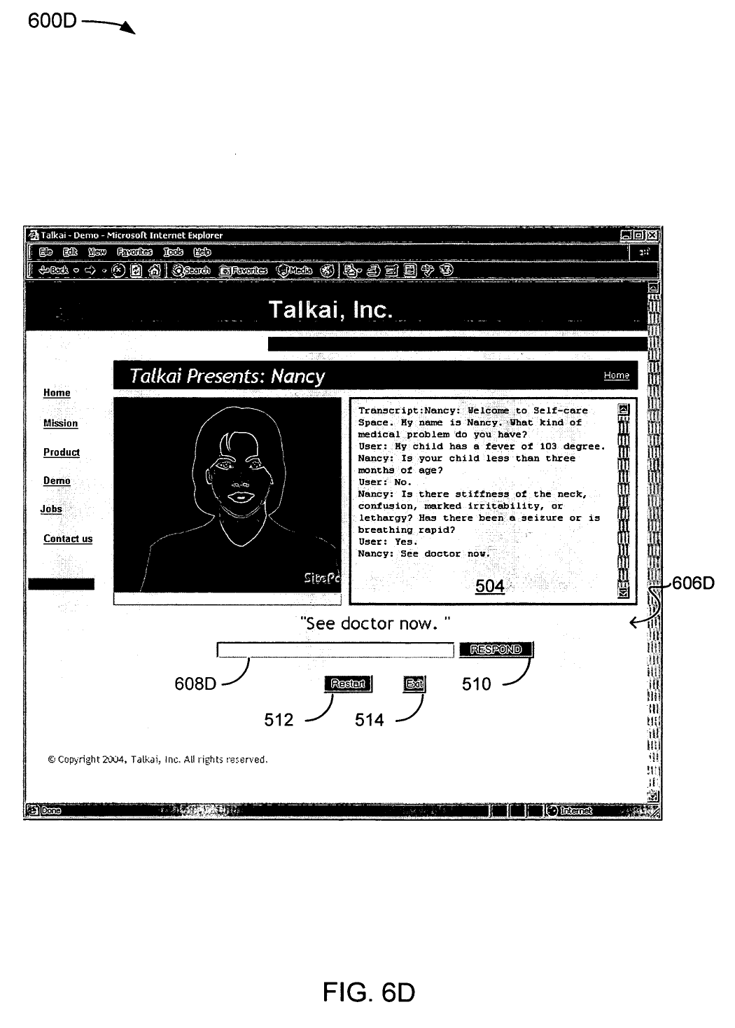

FIGS. 6A to 6D illustrate one of the advantages of natural language processing over keyword searching. FIG. 6A depicts a screenshot 600A that is similar to the screenshot 500A. Similar components have the same reference numerals as those described with reference to FIG. 5A, and descriptions of the similar components are omitted. In response to the prompt in the display area 606A, the user enters “My child has a fever of 103 degree.” Since the system can parse natural language, the system knows that the person with the fever is a child and that the fever is 103 degrees. An appropriate response can be generated with this information in mind.

In FIG. 6B, the system has processed the user's input and has a response, as displayed in the display area 606B of “Is your child less than three months of age?” This response makes use of the knowledge that the user has indicated that it is the user's child that is being discussed. For the purpose of example, the user enters “No.” in the text box 608B.

In FIG. 6C, the system has processed the user's input and has a response, as displayed in the display area 606C of “Is there stiffness of the neck, confusion, marked irritability, or lethargy? Has there been a seizure or is breathing rapid?” to which the user has responded, as shown in the text box 608C, with “Yes.” It should be noted that the system could have responded “Does your child have stiffness of the neck, confusion, marked irritability, or lethargy? Has your child had a seizure or is your child breathing rapidly?” This is because previously entered data may be maintained to provide responses as appropriate.

In FIG. 6D, the system has processed the user's input and has a response, as displayed in the display area 606D of “See doctor now.” Again, the system could have said “Take your child to the doctor now” because the system maintains previously entered data. In any case, the system assumes the dialogue has ended at this point and, for the purposes of example, the text box 608D is left blank.

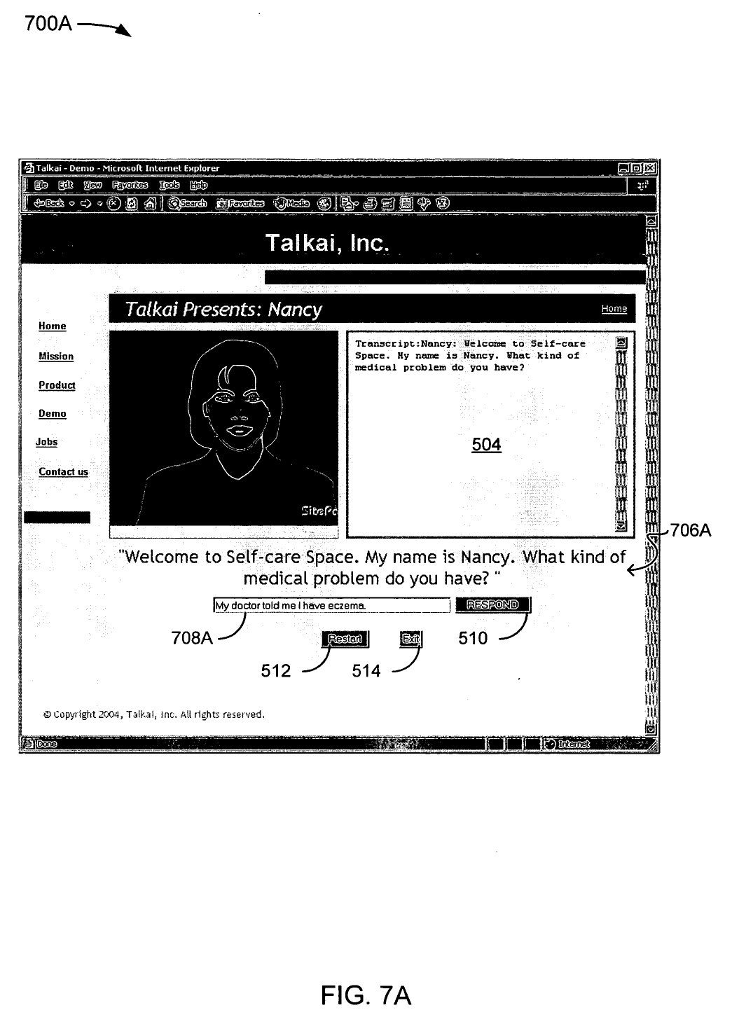

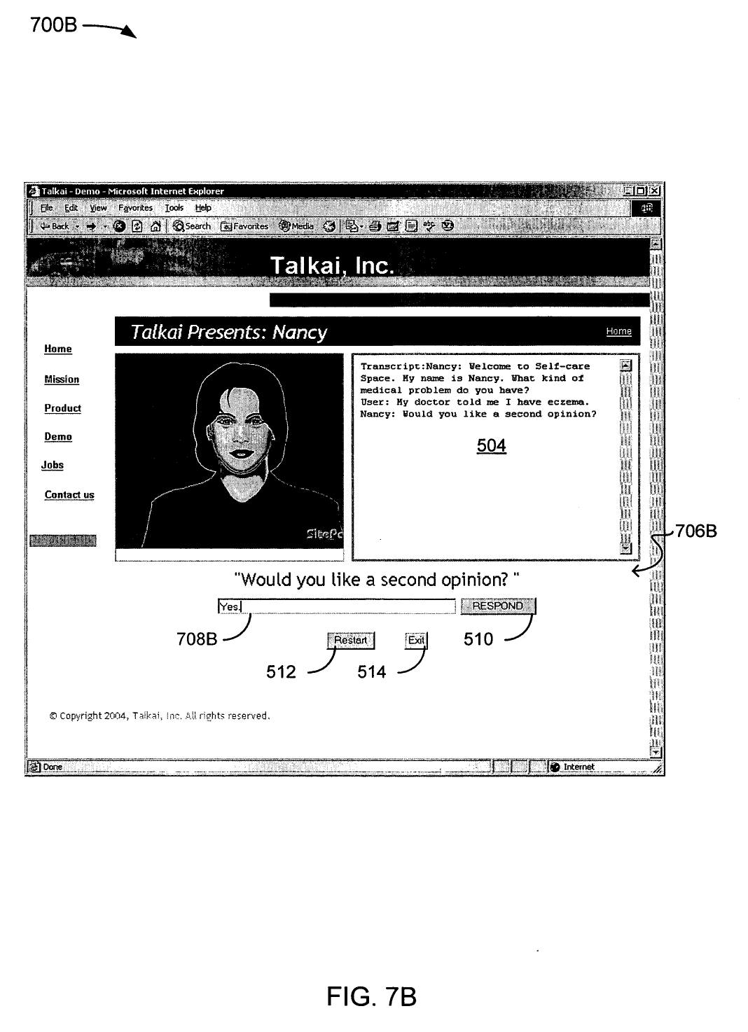

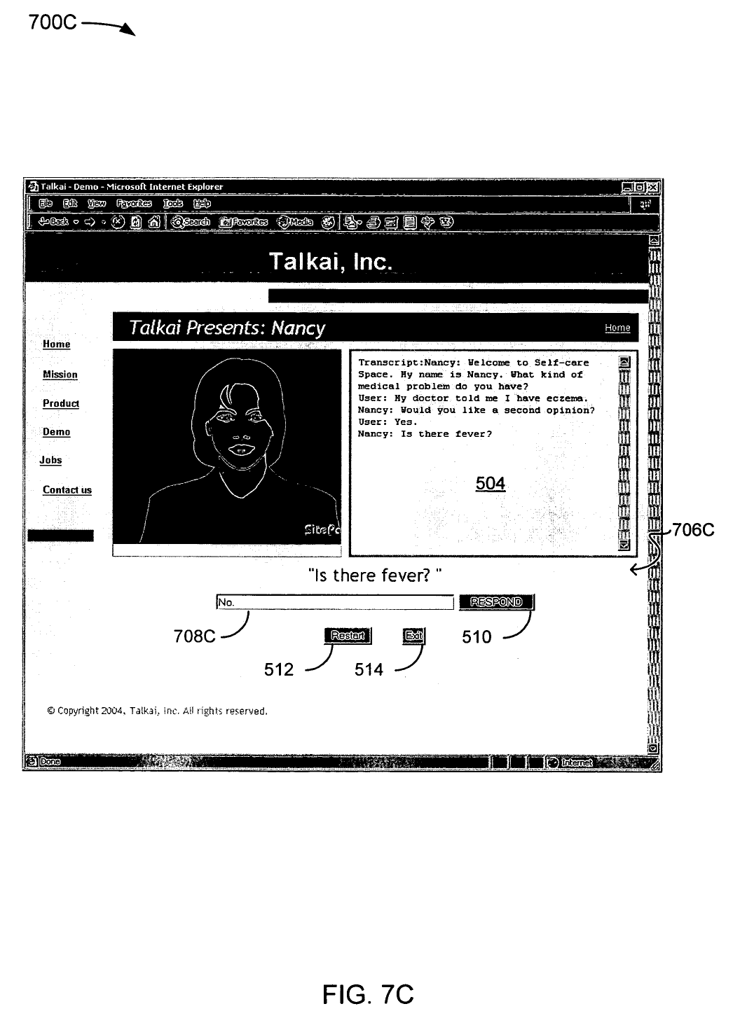

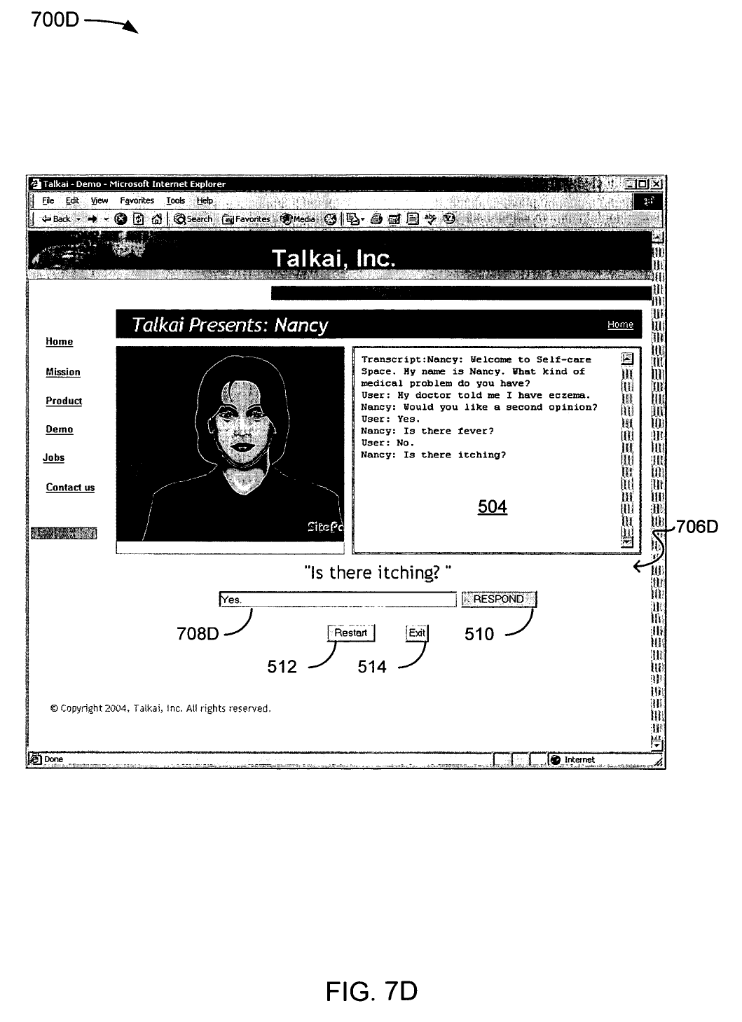

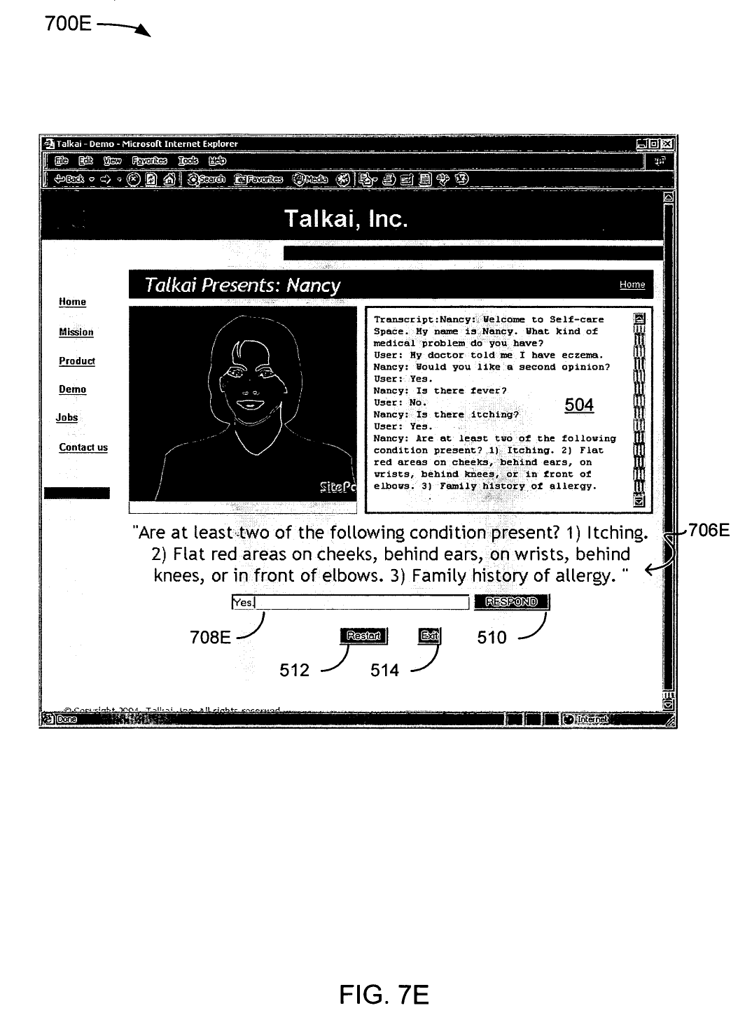

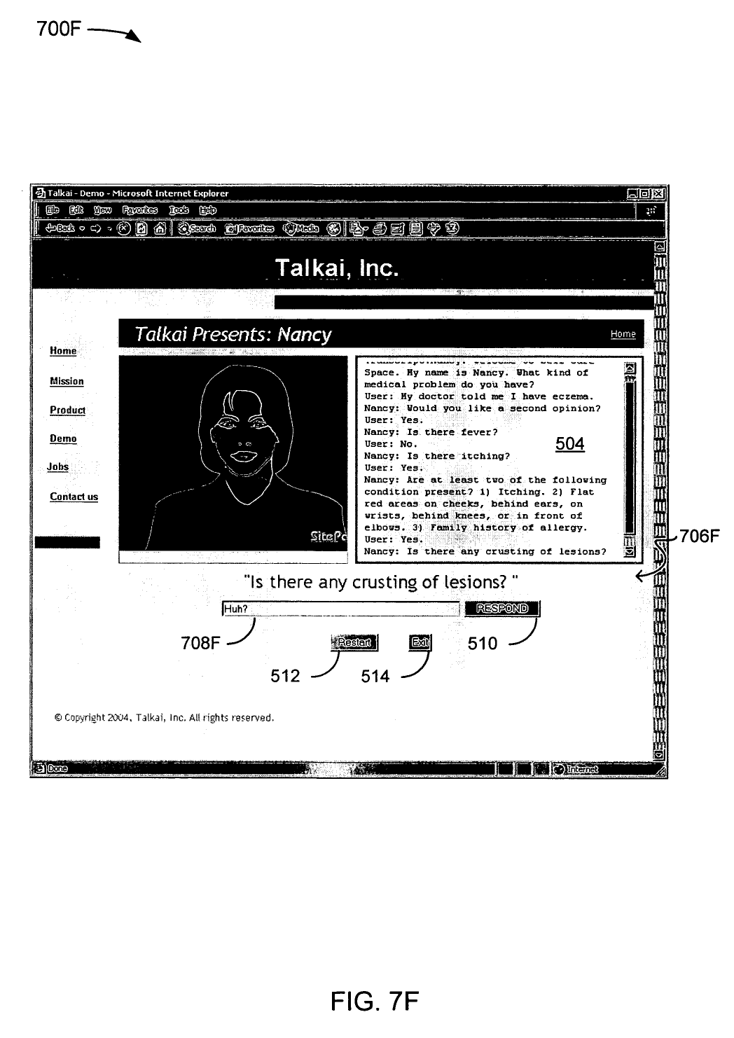

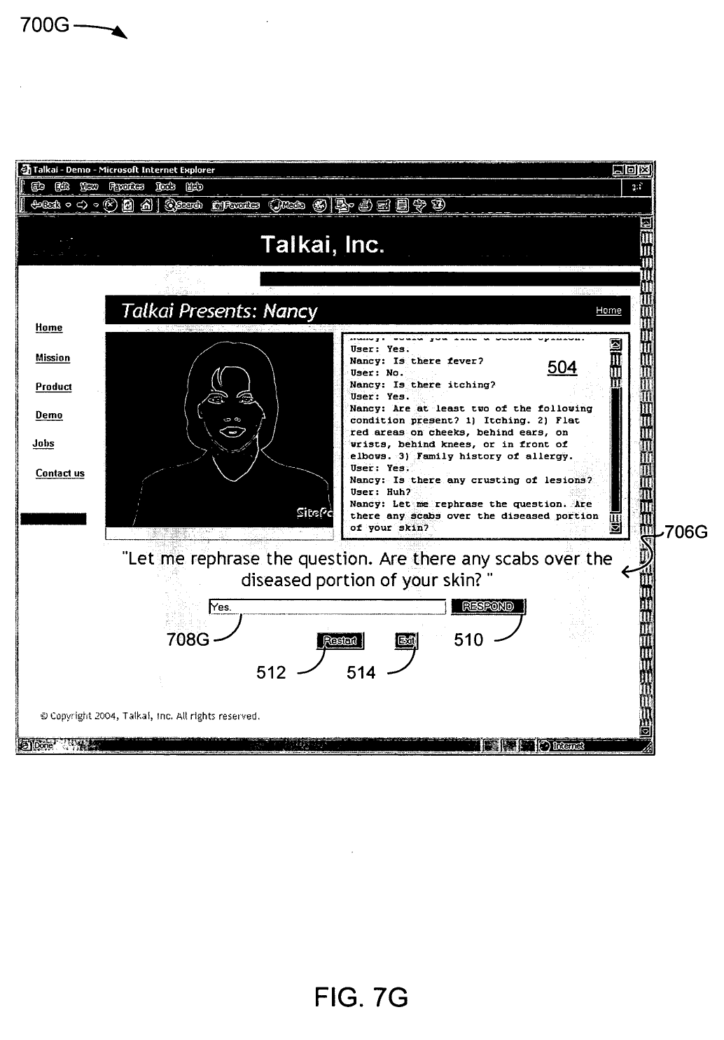

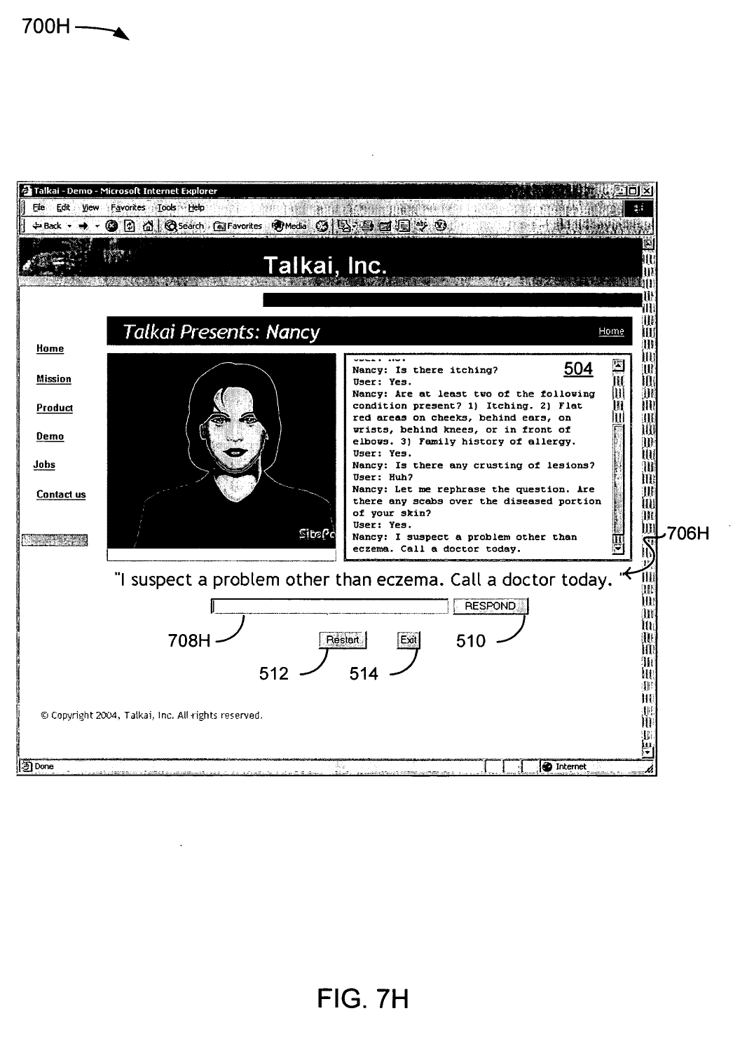

FIGS. 7A to 7H are intended to illustrate other advantages of an embodiment of the natural language consultation system. FIG. 7A depicts a screenshot 700A that is similar to the screenshot 500A. Similar components have the same reference numerals as those described with reference to FIG. 5A, and descriptions of the similar components are omitted. In response to the prompt in the display area 706A, the user enters “My doctor told me I have eczema.” Since the system can parse natural language, the system knows that the user may have eczema. The system also knows that a doctor told the user this. Accordingly, the system may pursue a path that first determines whether the user wants a second opinion, which may be a decision point that corresponds to a user indicating that the user has already been diagnosed by a doctor. While the system is in the self-help domain, which means it generally does not make use of detailed blood test results and the like, some diseases may be misdiagnosed by a doctor or, more likely, the user may simply want reassurance that the doctor is correct or to make sure that subsequent symptoms are normal for a diagnosed disease. An appropriate response can be generated with this information in mind.

In FIG. 7B, the system has processed the user's input and has a response, as displayed in the display area 706B of “Would you like a second opinion?” This response makes use of the knowledge that the user has indicated that a doctor has already provided a diagnosis. If the user does not want a second opinion, the system may ask some other question related to the symptoms of eczema, such as “have the symptoms changed?” (not shown). For the purpose of example, the user enters “Yes.” in the text box 708B.

In FIG. 7C, the system has processed the user's input and has a response, as displayed in the display area 706C of “Is there fever?” to which the user has responded, as shown in the text box 608C, with “No.” The system's query is in accordance with currently known data (e.g., state). The system is trying to determine whether the user has eczema to provide a second opinion in the matter. If there are skin problems, which is assumed because the user indicated they were diagnosed with eczema, then the system determines whether fever accompanies the problems in accordance with, for example, a diagnosis flowchart that begins with a determination of whether fever accompanies the skin problems.

In FIG. 7D, the system has processed the user's input and has a response, as displayed in the display area 706D of “Is there itching?” to which the user has responded, as shown in the text box 708D, with “Yes.”

In FIG. 7E, the system has processed the user's input and has a response, as displayed in the display area 706E of “Are at least two of the following conditions present? 1) Itching. 2) Flat red areas on cheeks, behind ears, on wrists, behind knees, or in front of elbows. 3) Family history of allergy.” to which the user has responded, as shown in the text box 708E, with “Yes.” It should be noted that the system could have asked “Are one of the following conditions present?” and omitted the question about itching because the user has already indicated that itching is present.

In FIG. 7F, the system has processed the user's input and has a response, as displayed in the display area 706F of “Is there any crusting of lesions?” to which the user has responded, as shown in the text box 708F, with “Huh?” In this example, it is assumed that the user does not understand the question. Since the system can understand the response, the system can respond in a meaningful way. A keyword-based system would probably be unable to respond to “Huh?”

In FIG. 7G, the system has processed the user's input and has a response, as displayed in the display area 706G of “Let me rephrase the question. Are there any scabs over the diseased portion of your skin?” to which the user has responded, as shown in the text box 708G, with “Yes.”

In FIG. 7H, the system has processed the user's input and has a response, as displayed in the display area 706H of “I suspect a problem other than eczema. Call a doctor today.” Since the system maintains state (e.g., the system is determining whether the user has eczema), the system can incorporate the state into the diagnosis, as illustrated.

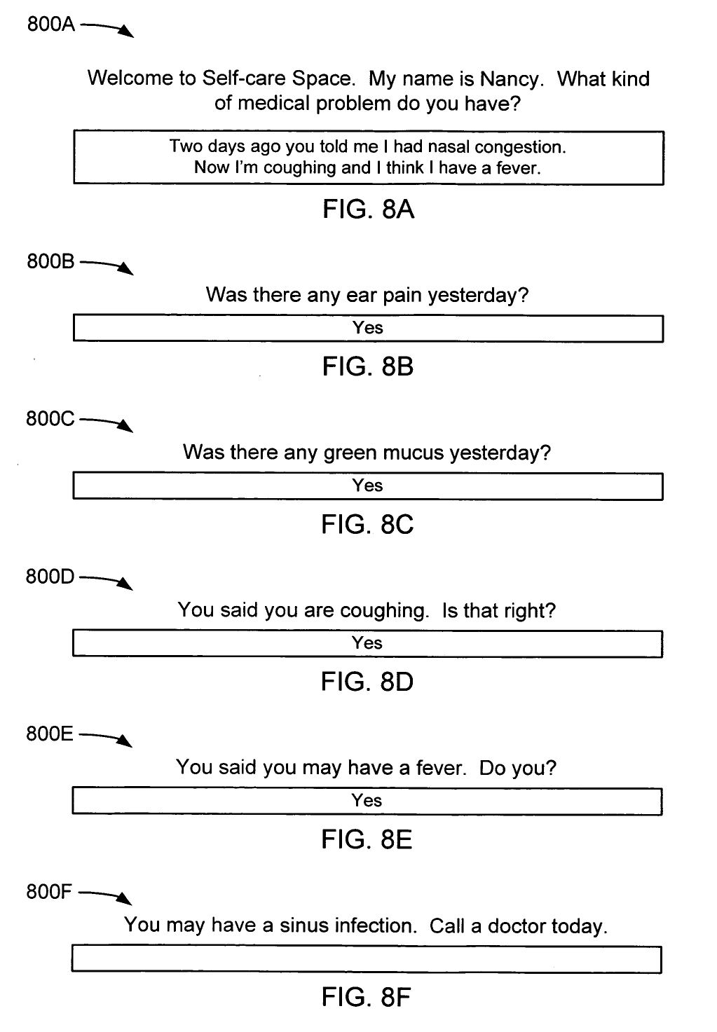

FIGS. 8A to 8F are intended to illustrate other advantages of an embodiment of the natural language consultation system.

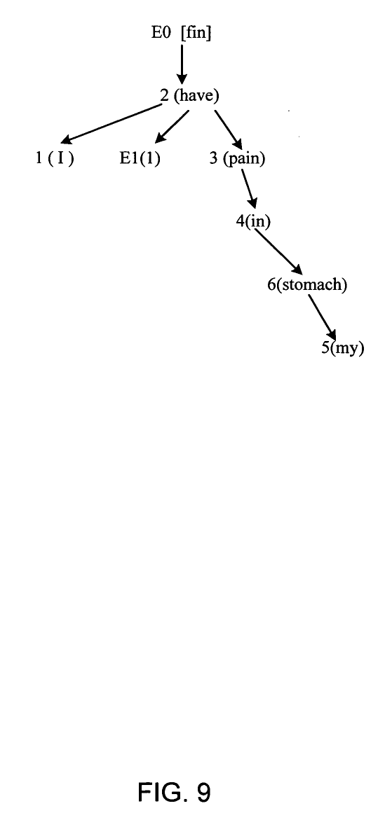

FIG. 9 depicts a tree structure of a parsed sentence according to an embodiment. The parsed sentence is, in the example of FIG. 9, “I have pain in my stomach.” Reference is made to Table 1, below, in the description of FIG. 9.

TABLE 1
A Parse Table

| Label | Word | Root | Category | Parent | Relation | Gov | Attr |
|---|---|---|---|---|---|---|---|
| E0 | ( ) | fin | C | * | | | |
| 1 | I | I | N | 2 | s | have | (3sg −) (vform bare)) |
| | | | | | | | (plu −) (pron +)) |
| 2 | have | have | V | E0 | i | fin | (3sg −) (passive −) |
| | | | | | | | (plu −) (vform bare)) |
| E1 | ( ) | I | N | 2 | subj | have | (3sg −) (plu −) (pron +)) |
| 3 | pain | pain | N | 2 | obj | have | |
| 4 | in | in | Prep | 3 | mod | pain | (adv +) (pform in)) |
| 5 | my | my | N | 6 | gen | stomach | (plu −) (pron +)) |
| 6 | stomach | stomach | N | 4 | pcomp-n | in | |

The columns of Table 1 are as follows:
Label: The index of nodes on the tree.
Word: The original word from user input.
Root: The root form of a word. For example, the root form of “had” is “have”, the root form of “tears” is “tear.”
Categories (Grammatical Categories):

C: Clauses

N: Noun and Noun Phrases

V: Verb and Verb Phrases

Prep: Preposition and Prepositional Phrases.
Parent: The parent node of the current node.
Relation (Grammatical Relationships)

obj Object of verbs

subj (deep subject) Subject of verbs

s Surface subject

i The main verb of a clause.
Gov: Root of the Parent node.
Attr: Attributes of the word.

A first step in preparing a parse tree for the example sentence is adding each word of the sentence to a parse table and assigning a label. For example, the sentence “I have pain in my stomach.” could be represented in the table by assigning the word “I” the label 1, the word “have” the label 2, the word “pain” the label 3, and so forth. Additional nodes may be added to the list of words, such as the nodes E0 and E1. In an embodiment, E0 exists for all sentences and represents the root of the sentence. However, other than the root node, these types of nodes are, for the most part, placeholders for values that may or may not be present in the sentence. For example, a verb can have a subject and an object, so a “placeholder” node E1 and E2 can be designated for the verb. If the verb does not have, for example, a subject, then the node E1 may be left as an artifact of the parsing process and the object of the verb may take the place of the placeholder node E2. Since E0 represents the root node, it is not simply a placeholder, and, in an embodiment, is not replaced with a node that corresponds to an input word.

In Table 1, E0 represents the root of the parse tree. Since all sentences have the root node, the E0 entry could naturally have been added to Table 1 prior to adding the words of the sentence. Other nodes, such as E1, may not be known until the sentence has been at least partially analyzed or parsed. In the example FIG. 9, the placeholder node E1 would not be known until it was determined that the word “have” is a verb. Since verbs can be transitive or intransitive, they can potentially have two associated grammatical components, subject and object. Accordingly, an E1 and E2 placeholder may be generated once it is known that “have” is a verb. As depicted in FIG. 9, there is no E2 because it was replaced with the object of the verb “have”. However, E1 remains as an artifact of the parsing process. In an alternative, all of the rows of the table are added simultaneously or sequentially after pre-processing or parsing the sentence.

As depicted in FIG. 9, the parse tree 900 begins at a root node E0. The root node includes information about the sentence. As shown in Table 1, above, ( ) is the entry in the Word column. This is because the root node E0 is not associated with an input word. “fin” is the entry in the Root column, which is a code word indicating that this is a root node. Of course, “fin” is not actually the root form of a word that is contained in the sentence. “C” is the entry in the Category column. “C” indicates that the parsed sentence is a clause, which typically means that the sentence is a statement rather than, for example, a question. A root node does not have a parent. Accordingly, there is no entry in the Parent column. Similarly, the root node does not have a grammatical relationship with other nodes so there is no entry in the Relation column. Since the root node does not have a parent, there is no entry in the Gov column. Since the root node does not have an associated word, there is no entry in the Attr column.

The word “I” corresponds to the node 1, “have” to node 2, and so forth. The entries in each of the columns of Table 1 contain grammatical data and data related to the relationship of a word with the rest of the sentence.

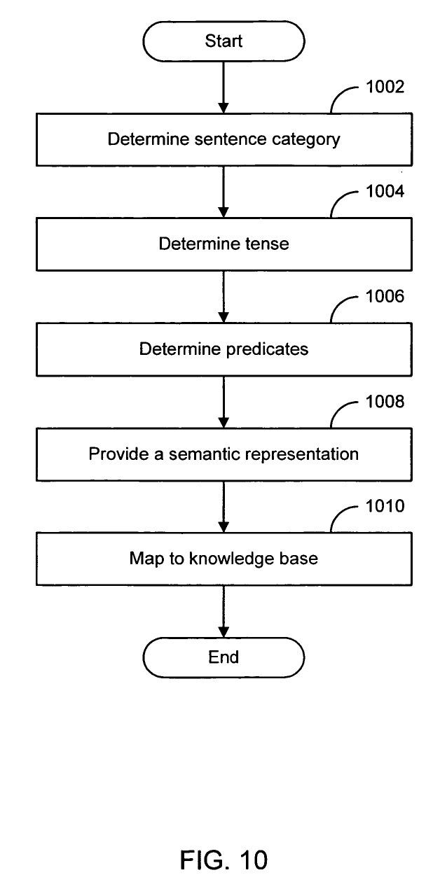

FIG. 10 are flowcharts intended to illustrated various procedures of the general-purpose interpreter. For illustrative purposes only, the description with reference to the example of FIG. 10 includes references to the parse tree depicted in FIG. 9. The general-purpose interpreter begins at block 1002 by determining the category of a sentence. The interpreter may check the Category column of Table 1 for the category of the root node. A category of C indicates a clause, which means that the sentence is a statement. Other categories may indicated that the sentence is a yes/no question, a wh*/how question, a command, or an exclamation.

The flowchart continues at block 1004 with determining the tense of the sentence. In the example of FIG. 9, the sentence is in present tense. This corresponds to the attributes of the root node (vform bare).

The flowchart continues at block 1006 with determining predicates. There is no modal verb in the example sentence and the sentence may be represented as collection of predicates. In the example of FIG. 9, the predicates are: Have (I, pain, in) && in(stomach) && stomach(my). Each predicated belongs to one of five types of words: verb, preposition, noun, adjective, and adverb. Each predicate has a number of associated slots, for example: Verb(subj, obj, advp1, advp2, . . . ), Preposition(noun-phrase), Noun(possessive, adj1, advp1, adjp2, advp2, . . . ), Adjective(subj), and Adv(advp1, advp2,

The flowchart continues at block 1008 with providing a semantic representation for one or more of the predicates. In an embodiment, the interpreter includes a database. The database includes multiple IF-THEN statements that facilitate understanding of the sentence. For example, the database may include the statement: If In(x) && x in(body-parts) && pain → “x pain”. This means that if there is pain in a body part x, then this can be converted to a semantic representation “X pain”. Accordingly, the semantic representation for the symptom that is understood from the example sentence of FIG. 9 is “stomach pain”.

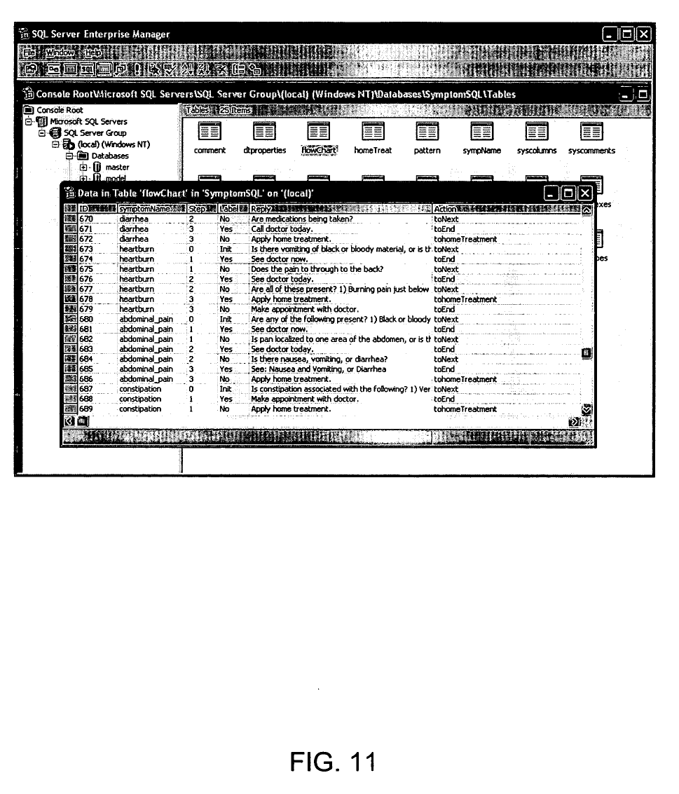

The flowchart continues at block 1010 with mapping to a knowledge base. Continuing the example above, the semantic representation “stomach pain” is mapped onto a symptom name. For example, “stomach pain” may map to “heartburn” through a table that includes a list of semantic representations and associated symptom names. A symptom name may refer to a suspected diagnosis. For example, stomach pain could mean that a patient has heartburn. However, stomach pain could map to more than one symptom name, such as “ulcers.” In this case, the dialogue may first explore one potential diagnosis (e.g., heartburn) and, depending upon the success or failure of the potential diagnosis, explore another potential diagnosis (e.g., ulcers). In an embodiment, a semantic representation maps to only one potential diagnosis, which may change over the course of a dialogue with a patient. In another embodiment, the semantic representation maps to more than one potential diagnosis, and the diagnoses are explored sequentially or simultaneously. Once the symptom name, such as “heartburn” has been determined, a flowchart table is consulted to help generate dialogue relevant to determining whether the suspected diagnosis is correct. FIG. 11 depicts a screenshot of a flowchart in database format.

Appendix A includes a list of symptoms, questions that are appropriate to further explore a diagnosis given the symptom, and actions to be taken when additional data is received from the user.

Appendix B includes a list of words and the symptoms with which they are associated.

What is claimed is:

1. A computer program product for use in one or more computing devices comprising a computer readable storage medium and a computer program mechanism embedded therein, the computer program product comprising:
a user interface module for receiving natural language input and for providing a response to the natural language input;
a broad-coverage parser module for parsing the natural language input into a representational grammar;
a general-purpose interpreter module for converting the representational grammar into a semantic representation; and
a domain-based knowledge base module for determining meaning from the semantic representation.

2. The computer program product of claim 1, further comprising: a speech-to-text module for converting spoken natural language input to text.

3. The computer program product of claim 1, further comprising: a dialogue manager module for maintaining state, editing the state in response to the natural language input, and deriving an appropriate response to the natural language input based upon the state.

4. The computer program product of claim 1, further comprising: a text-to-speech module for providing a spoken language reply to the natural language input.

5. The computer program product of claim 1, wherein the domain-based knowledge base module is in a medical domain.

6. The computer program product of claim 1, wherein the domain-based knowledge base module is in a coaching domain.

7. The computer program product of claim 1, wherein the domain-based knowledge base module is in a psychotherapy domain.

8. A method for applying natural language dialogue to consultation in a specific domain, comprising:
receiving natural language input;
parsing the natural language input into representational grammar;
converting the representational grammar into a semantic representation;
determining meaning from the semantic representation;
editing state; and
deriving an appropriate response based upon the state and the determined meaning of the natural language input.

9. The method of claim 8, wherein the meaning is determined based upon stored knowledge associated with the specific domain.

10. The method of claim 8, further comprising providing the appropriate response based upon the state and the determined meaning of the natural language input.

11. The method of claim 8, wherein the specific domain is a medical domain.

12. The method of claim 8, wherein the specific domain is a coaching domain.

13. The method of claim 8, wherein the specific domain is a psychotherapy domain.

14. A method for applying natural language dialogue to consultation in a medical domain, comprising:
asking a user what kind of medical problem the user has;
responding to the problem with follow-up questions that are effective to help diagnose the medical problem based upon state associated with the medical problem and a knowledge base; and
diagnosing the medical problem based upon the state.

15. The method of claim 14, further comprising determining meaning of input from the user using a knowledge base that includes information about entailments of predicates.

16. The method of claim 14, further comprising determining meaning of input from the user using a knowledge base that includes information about the world.

17. The method of claim 14, further comprising determining meaning of input from the user using a knowledge base that includes general world knowledge.

18. The method of claim 14, further comprising reasoning based on information from a knowledge base.

19. The method of claim 14, further comprising using a self-help ontology to provide a basic diagnosis of a potential illness based on symptoms the user provides as input.

20. The method of claim 14, further comprising using a medical ontology to provide a diagnosis of a potential illness based upon collected data the user provides as input.
